(19) United States
(12) Patent Application Publication
(10) Pub. No.: US 2006/0050017 A1
(43) Pub. Date: Mar. 9, 2006

(54) Plasma display apparatus and image processing method thereof

(76) Inventors: Seong Hak Moon, Seoul (KR); Chang Ho Hyeon, Yongin-si (KR); Seung Chan Baek, Seoul (KR)

Correspondence Address: Song K. Jung;MCKENNA LONG & ALDRIDGE LLP, 1900 K Street, N.W., Washington, DC, 20006, US

(21) Appl. No.: 11/220,564

(22) Filed: Sep. 8, 2005

(30) Foreign Application Priority Data
Sep. 8, 2004 (KR) 10-2004-0071918

(51) Int. Cl. G09G 3/10

(52) U.S. Cl. 345/41

(57) ABSTRACT

Provided are a plasma display apparatus which performs error diffusion and an image processing method of a plasma display apparatus. The plasma display apparatus comprises an APL calculation block for calculating an APL upon receipt of an image signal, a displacement noise calculation block for calculating the intensity of overall displacement noise corresponding to the amount of displacement of an image of the image signal according to a displacement noise calculation value including the APL, a displacement noise supply block for supplying a displacement noise signal to the image signal according to the intensity of the overall displacement noise, a halftone block for performing halftoning for the image signal to which the displacement noise signal is applied and a plasma display panel for displaying an image corresponding to the signal output from the halftone block. Picture quality can be improved because noise caused by error diffusion can be reduced.

This Nonprovisional application claims priority under 35 U.S.C. § 119(a) on Patent Application No. 2004-0071918 filed in Korea on Sep. 08, 2004, the entire contents of which are hereby incorporated by reference.

### BACKGROUND OF THE INVENTION

1. Field of the Invention

The present invention relates to a plasma display apparatus and an image processing method thereof, and more particularly, to a plasma display apparatus using halftoning and an image processing method thereof.

2. Background of the Related Art

Generally, a plasma display apparatus uses a plurality of subfields in order to produce one image frame. Each of the subfields has a given brightness. A general plasma display apparatus represents a gray level by combining the subfields.

FIG. 1 is a view for explaining a gray level representation of a general plasma display apparatus. When the plasma display apparatus operates in 60 Hz mode, the plasma display apparatus should display a total of 60 frames per second. Thus, the time allotted per frame is 16.7 ms.

The plasma display apparatus performs addressing for discriminating cells to be turned on from cells to be turned off in each of the subfields. The addressing is performed in an addressing period 1 of FIG. 1.

Since a predetermined amount of charges are accumulated in the cells to be turned on after the addressing, when the plasma display apparatus applies a sustain pulse to these cells in a sustain period, light emission is performed. For instance, in a case where eight subfields are used, each of the subfield has a weight of 1, 2, 4, 8, 16, 32, 64 and 128, respectively, thus maximum 256 gray levels can be represented by a combination of these subfields.

Therefore, if a larger number of subfields are used, a larger number of gray levels can be represented. However, the time allotted per frame is limited, the number of subfields used is 12 or less. The number of gray levels obtainable when 12 subfields are used is 2¹², which is fairly large. However, not every gray levels formed of 12 subfields are used due to false contour.

Considering a combination of specific subfields in which false contour occur, the number of gray levels that can be actually produced is reduced to a considerable extent. Thus, a general plasma display apparatus uses a halftoning method in order to represent a large number of gray levels using a small number of gray levels. Such a halftoning method includes error diffusion, dithering and so on. The plasma display apparatus uses error diffusion based on the Floyd Steinberg method and dithering using a dither mask.

The plasma display apparatus eliminates a pattern noise generated from dithering by using error diffusion when representing a moving image. However, in a case where the plasma display apparatus receives a still image from a PC (personal computer) for a long time, noise caused by error diffusion is manifested at a fixed position for a long time. In the plasma display apparatus, the lower an APL (Average Picture Level) is, the larger number of sustain pulses each subfield is allocated. Thus, the more the luminance difference between actual gray level values, the more serious noise caused by error diffusion becomes. Further, when the plasma display apparatus displays a dark image with a lot of low gray levels, the error diffusion noise level gets higher.

### SUMMARY OF THE INVENTION

Accordingly, an object of the present invention is to solve at least the problems and disadvantages of the background art.

The present invention provides a plasma display apparatus which performs error diffusion and an image processing method thereof.

The plasma display apparatus of the present invention comprises: an APL calculation block for calculating an APL upon receipt of an image signal; a displacement noise calculation block for calculating the intensity of overall displacement noise corresponding to the amount of displacement of an image of the image signal according to a displacement noise calculation value including the APL; a displacement noise supply block for supplying a displacement noise signal to the image signal according to the intensity of the overall displacement noise; a halftone block for performing halftoning for the image signal to which the displacement noise signal is applied; and a plasma display panel for displaying an image corresponding to the signal output from the halftone block.

The plasma display apparatus of the present invention comprises: an APL calculation block for calculating an APL upon receipt of an image signal; a displacement noise calculation block consisting of a first calculation block for calculating the intensity of displacement noise corresponding to the amount of displacement of an image of the image signal according to a displacement noise calculation value including the APL calculated by the APL calculation block, a second calculation block for calculating the intensity of displacement noise according to a displacement noise calculation value including a gray level value corresponding to the image signal, and an overall calculation block for calculating the intensity of overall displacement noise according to the displacement noise calculation value including the result of calculation of the first calculation block and the result of calculation of the second calculation block; a displacement noise supply block for supplying a displacement noise signal to the image signal according to the intensity of the overall displacement noise; a halftone block for performing halftoning for the image signal to which the displacement noise signal is applied; and a plasma display panel for displaying an image corresponding to the signal output from the halftone block.

The image processing method of a plasma display apparatus of the present invention comprises the steps of: calculating an APL upon receipt of an image signal; calculating the intensity of overall displacement noise corresponding to the amount of displacement of an image of the image signal according to a displacement noise calculation value including the calculated APL; supplying a displacement noise signal to the image signal corresponding to the intensity of the overall displacement noise; performing halftoning for the image signal to which the displacement noise signal is applied; and supplying the halftoned image signal to electrodes.

The present invention can enhance picture quality by reducing noise caused by error diffusion.

### BRIEF DESCRIPTION OF THE DRAWINGS

The invention will be described in detail with reference to the following drawings in which like numerals refer to like elements:

FIG. 1 is a view for explaining a gray level representation of a general plasma display apparatus;

FIG. 2 is a graph showing the relation between an APL and a number of sustain pulses used in a plasma display apparatus;

FIG. 3a is a graph showing a change in displacement noise intensity depending on an APL according to the present invention;

FIG. 3b is a graph showing a change in displacement noise intensity depending on a gray level according to the present invention;

FIG. 4 is a block diagram of a plasma display apparatus according to a first embodiment of the present invention;

FIG. 5 is a sequence diagram of an image processing method according to the first embodiment of the present invention;

FIG. 6 is a block diagram of a plasma display apparatus according to a second embodiment of the present invention; and

FIG. 7 is a sequence diagram of an image processing method according to the second embodiment of the present invention.

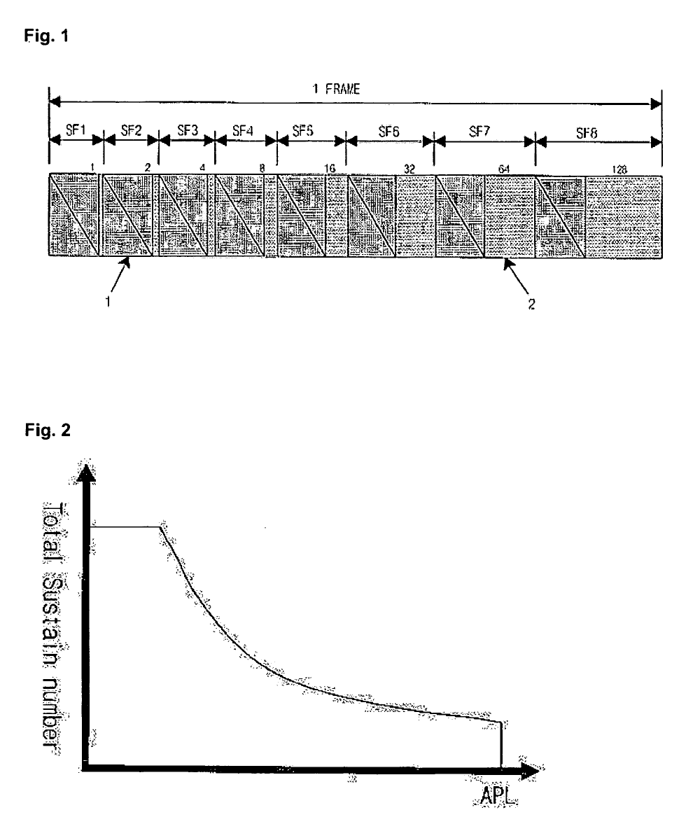

### DETAILED DESCRIPTION OF THE PREFERRED EMBODIMENTS

Preferred embodiments of the present invention will be described in a more detailed manner with reference to the drawings.

The plasma display apparatus of the present invention comprises: an APL calculation block for calculating an APL upon receipt of an image signal; a displacement noise calculation block for calculating the intensity of overall displacement noise corresponding to the amount of displacement of an image of the image signal according to a displacement noise calculation value including the APL; a displacement noise supply block for supplying a displacement noise signal to the image signal according to the intensity of the overall displacement noise; a halftone block for performing halftoning for the image signal to which the displacement noise signal is applied; and a plasma display panel for displaying an image corresponding to the signal output from the halftone block.

The displacement noise calculation block consists of a) a first calculation block for calculating the intensity of displacement noise corresponding to the amount of displacement of an image of the image signal according the APL calculated by the APL calculation block, b) a second calculation block for calculating the intensity of displacement noise according to a gray level value corresponding to the image signal, and c) an overall calculation block for calculating the intensity of overall displacement noise according to the displacement noise calculation value including the result of calculation of the first calculation block and the result of calculation of the second calculation block.

The displacement noise calculation block calculates the intensity of overall displacement noise which becomes greater as the APL becomes smaller.

The second calculation block calculates the intensity of displacement noise which becomes greater as the gray level value becomes smaller.

The first calculation block calculates the intensity of displacement noise which becomes greater as the APL becomes smaller, and the second calculation block calculates the intensity of displacement noise which becomes greater as the gray level becomes smaller.

The displacement noise calculation block calculates the intensity of overall noise according to the following mathematical formula:

NLEVEL=a*NAPL

NLEVEL: intensity of overall displacement noise

NAPL: intensity of displacement noise depending on APL

a: proportional constant.

The displacement noise calculation block calculates the intensity of overall noise according to the following mathematical formula:

NLEVEL=a*(NAPL*NGL)

NLEVEL: intensity of overall displacement noise

NAPL: intensity of displacement noise depending on APL

NGL: intensity of displacement noise depending on gray level of pixel

a: proportional constant

The plasma display apparatus of the present invention comprises: an APL calculation block for calculating an APL upon receipt of an image signal; a displacement noise calculation block consisting of a first calculation block for calculating the intensity of displacement noise corresponding to the amount of displacement of an image of the image signal according to a displacement noise calculation value including the APL calculated by the APL calculation block, a second calculation block for calculating the intensity of displacement noise according to a displacement noise calculation value including a gray level value corresponding to the image signal, and an overall calculation block for calculating the intensity of overall displacement noise according to the displacement noise calculation value including the result of calculation of the first calculation block and the result of calculation of the second calculation block; a displacement noise supply block for supplying a displacement noise signal to the image signal according to the intensity of the overall displacement noise; a halftone block for performing halftoning for the image signal to which the displacement noise signal is applied; and a plasma display panel for displaying an image corresponding to the signal output from the halftone block.

The first calculation block calculates the intensity of overall displacement noise which becomes greater as the APL becomes smaller.

The second calculation block calculates the intensity of displacement noise which becomes greater as the gray level becomes smaller

The first calculation block calculates the intensity of displacement noise which becomes greater as the APL becomes smaller, and the second calculation block calculates the intensity of displacement noise which becomes greater as the gray level becomes smaller.

The displacement noise calculation block calculates the intensity of overall noise according to the following mathematical formula:

NLEVEL=a*(NAPL*NGL)

NLEVEL: intensity of overall displacement noise

NAPL: intensity of displacement noise depending on APL

NGL: intensity of displacement noise depending on gray level of pixel

a: proportional constant

The image processing method of a plasma display apparatus of the present invention comprises the steps of: calculating an APL upon receipt of an image signal; calculating the intensity of overall displacement noise corresponding to the amount of displacement of an image of the image signal according to a displacement noise calculation value including the calculated APL; supplying a displacement noise signal to the image signal corresponding to the intensity of the overall displacement noise; performing halftoning for the image signal to which the displacement noise signal is applied; and supplying the halftoned image signal to electrodes.

The step of calculating the intensity of overall displacement noise consists of the steps of: a) calculating the intensity of displacement noise corresponding to the amount of displacement of an image of the image signal according a displacement noise calculation value including the; b) calculating the intensity of displacement noise using a displacement noise calculation value including a gray level value; and c) calculating the intensity of overall displacement noise according to the intensity of displacement noise depending on the APL and the intensity of displacement noise depending on the gray level value.

The intensity of overall displacement noise becomes greater as the APL becomes smaller.

The intensity of overall displacement noise becomes greater as the gray level value becomes smaller

The intensity of overall displacement noise becomes greater as the APL becomes smaller, and the intensity of overall displacement noise becomes greater as the gray level value becomes smaller

The intensity of overall displacement noise is calculated according to the following mathematical formula:

NLEVEL=a*NAPL

NLEVEL: intensity of overall displacement noise

NAPL: intensity of displacement noise depending on APL

a: proportional constant.

The intensity of overall noise is calculated according to the following mathematical formula:

NLEVEL=a*(NAPL*NGL)

NLEVEL: intensity of overall displacement noise

NAPL: intensity of displacement noise depending on APL

NGL: intensity of displacement noise depending on gray level of pixel

a: proportional constant

Hereinafter, specific embodiments of the present invention will be described with reference to the accompanying drawings.

First, the concept of an image processing method of a plasma display apparatus of the present invention will be described.

FIG. 2 is a graph showing the relation between an APL and a number of sustain pulses used in a plasma display apparatus. As shown in FIG. 2, the lower an APL (Average Picture Level) is, the larger number of sustain pulses the plasma display apparatus allocates to subfields in order to reduce power consumption. Thus, the contrast of an image corresponding to frames with a low APL is improved. Further, the plasma display apparatus reduces power consumption by reducing the number of sustain pulses allocated to subfields as the APL increases. Therefore, noise caused by error diffusion appears more strongly in the event the APL of frames of a still image is low. That is, because the lower the APL is, the larger number of sustain pulses the plasma display apparatus allocates, the luminance of error diffusion noise in a still image increases, thereby making the noise caused by error diffusion remarkable.

Accordingly, in the plasma display apparatus and image processing method of the present invention, a displacement noise signal is applied to an original image signal according to the APL of a frame, to thus displace the position of noise caused by error diffusion a certain amount for each frame. That is, since the position of noise by error diffusion is fixed in a still image, the noise caused by error diffusion is remarkable. Especially, as explained above, the lower the APL of frames of a still image is, the more remarkable the noise caused by error diffusion is. Therefore, if the position of noise caused by error diffusion is displaced a little, the phenomenon of remarkable noise caused by error diffusion decreases.

Such noise caused by error diffusion is affected by whether a gray level is high or not as well as by an APL. In other words, because noise caused by error diffusion occurs in the procedure of diffusing an error into adjacent cells, if a gray level corresponding to a cell is a low gray level, the difference between an error and an actual gray level is relatively reduced, thereby making noise caused by error diffusion remarkable in low gray levels.

Therefore, in the plasma display apparatus and image processing method of the present invention, the position of noise caused by error diffusion is displaced a certain amount for each frame by applying a displacement noise signal to an original image signal according to a corresponding gray level of a frame.

According to the concept of the aforementioned image processing method of the present invention, the intensity of displacement noise is determined according to the following mathematical formula. Here, the intensity of displacement noise corresponds to the amount of displacement of the position of noise caused by error diffusion for each frame. Once the intensity of noise is set, a displacement noise signal corresponding to the intensity of displacement noise is applied to an original image.

[Mathematical Formula]

NLEVEL=a*(NAPL*NGL)

NGL: intensity of displacement noise depending on gray level of pixel

NAPL: intensity of displacement noise depending on APL

NLEVEL: intensity of overall displacement noise

a: proportional constant

At this point, proportional constant ais a value determined by considering the characteristics of the plasma display apparatus and the like.

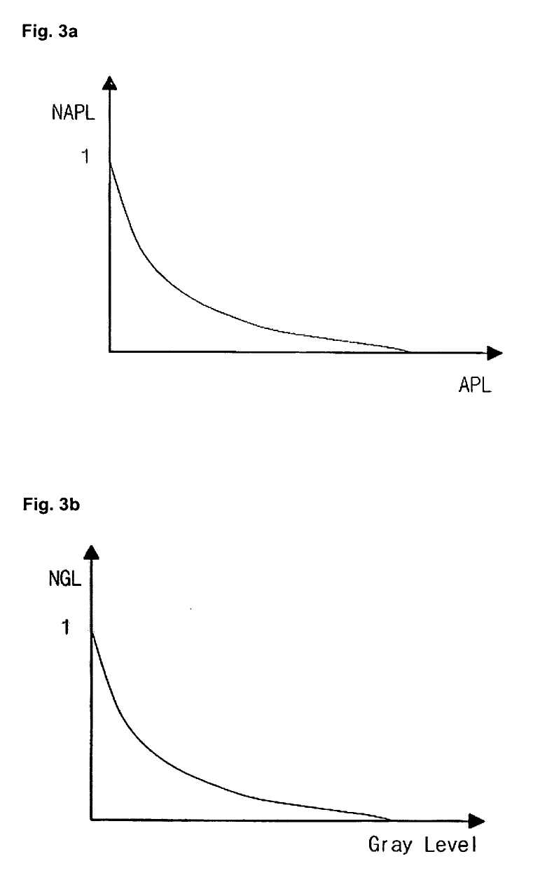

FIG. 3a is a graph showing a change in displacement noise intensity depending on an APL according to the present invention. As shown in FIG. 3a, if an APL is low, a NAPL is high, while if an APL is high, an NAPL is low. That is, in case of a low APL, a large number of sustain pulses are allocated to subfields, to thus increase noise caused by error diffusion. Therefore, in the plasma display apparatus and image processing method of the present invention, the lower an APL is, the higher the intensity of displacement noise becomes, thereby increasing the displacement of the position of noise caused by error diffusion.

FIG. 3b is a graph showing a change in displacement noise intensity depending on a gray level according to the present invention. As shown in FIG. 3b, if a gray level is low, an NGL is high, while if a gray level is high, an NGL is low. That is, in case of a low gray level, the difference between an error in an error diffusion procedure and an actual gray level becomes relatively smaller, thereby increasing noise caused by error diffusion. Therefore, in the plasma display apparatus and image processing method of the present invention, the lower a gray level is, the higher the intensity of displacement noise becomes, thereby increasing the displacement of the position of noise caused by error diffusion.

In the aforementioned plasma display apparatus and image processing method of the present invention, it is most preferable that the intensity of overall displacement noise is calculated by the relation between an APL and a gray level, but it may also be possible to calculate the intensity of overall displacement noise by each of them.

### <Embodiment 1>

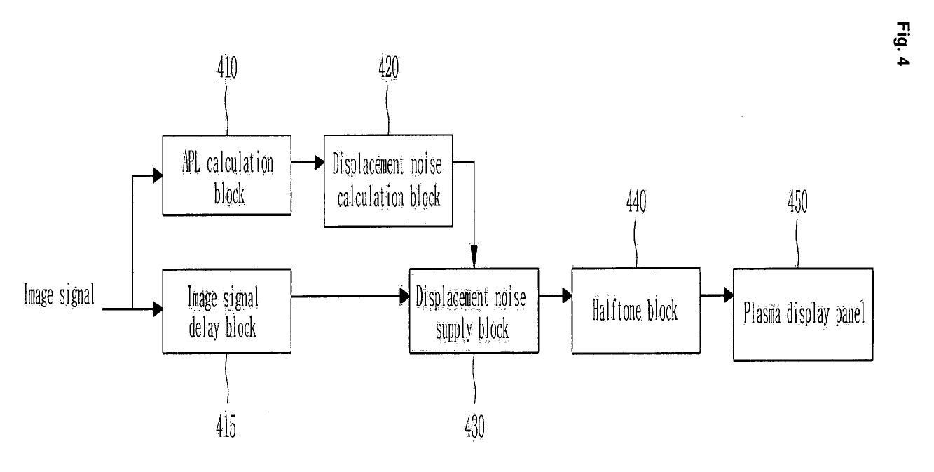

FIG. 4 is a block diagram of a plasma display apparatus according to a first embodiment of the present invention. As shown in FIG. 4, the plasma display apparatus of the first embodiment comprises an APL calculation block 410, a displacement noise calculation block 420, a displacement noise supply block 430, a halftone block 440, and a plasma display panel 450.

The APL calculation block 410 calculates an APL upon receipt of an image signal. At this point, the APL is a value obtained by dividing the total sum of gray levels of entire pixels by the number of entire pixels of one frame.

An image signal delay block 415 receives an image signal and delays the image signal for a predetermined time period. At this point, the image signal delay block 415 includes a memory block (not shown) for temporarily storing an image signal corresponding to one frame, to thus delay the image signal for a predetermined time period. Since the APL is a value obtained by dividing the total sum of entire pixels by the number of entire pixels, a delay for a predetermined time period (one frame) is done.

The displacement calculation block 420 calculates the intensity of overall displacement noise corresponding to the amount of displacement of an image corresponding to an image signal according to a displacement noise calculation value including the APL calculated by the APL calculation block 410.

The displacement noise calculation block 420 according to the first embodiment calculates the intensity of displacement noise corresponding to a displacement noise calculation value including a*NAPL in the above mathematical formula.

The displacement noise supply block 430 supplies a displacement noise signal to an image signal delayed for one frame according to the intensity of displacement noise calculated by the displacement noise calculation block 420. Therefore, the image signal outputted from the displacement noise supply block 430 corresponds to an image displaced a predetermined amount from the image generated from the original image signal. That is, the APL calculation block 410 calculates an APL upon receipt of an image signal corresponding to an (n-1)th frame. The image signal delay block 415 delays the image signal by one frame period by storing the image signal for the (n-1)th frame while the calculation of the APL for the (n-1)th frame is carried out. Subsequently, a displacement noise signal for the (n-1)th frame is applied to the image signal for the (n-1)th frame.

The halftone block 440 performs halftoning for the image signal to which the displacement noise signal is applied.

The plasma display panel 450 displays an image corresponding to the signal outputted from the halftone block 440.

Next, an image processing method of a plasma display panel according to the present invention will be described in detail with reference to the accompanying drawings.

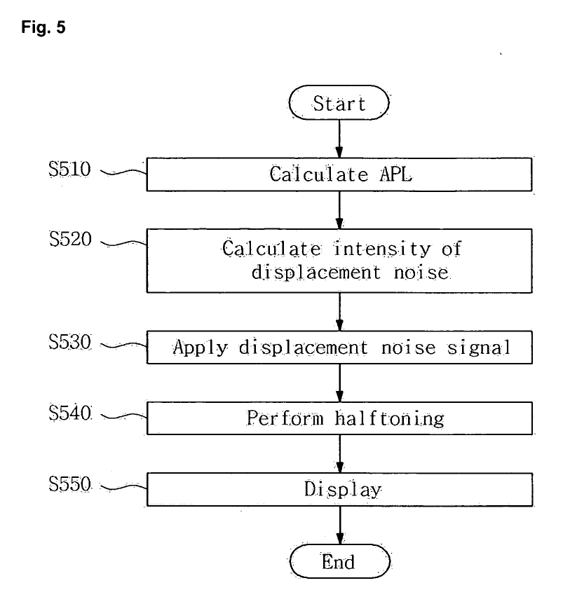

FIG. 5 is a sequence diagram of an image processing method according to the first embodiment of the present invention.

First, an APL calculation block 410 receives an image signal, and then calculates an APL by calculating the total sum of gray levels of entire pixels and dividing the total sum by the number of entire pixels (S510).

An displacement noise calculation block 420 calculates the intensity of overall displacement noise corresponding to the amount of displacement of an image corresponding to an image signal according to a displacement noise calculation value including the APL calculated by the APL calculation block 410 (S520). The displacement noise calculation block 420 according to the first embodiment calculates only a*NAPL in the above mathematical formula.

Next, a displacement noise supply block 430 applies a displacement noise signal corresponding to the intensity of displacement noise to an image signal delayed by one frame period (S530)

A halftone block 440 performs halftoning for the image signal to which the displacement noise signal is applied (S540), and a plasma display panel 450 displays a halftoned image signal (S550). Subsequently, an image displaced a predetermined amount from the image generated from the original image signal is displayed.

### <Embodiment 2>

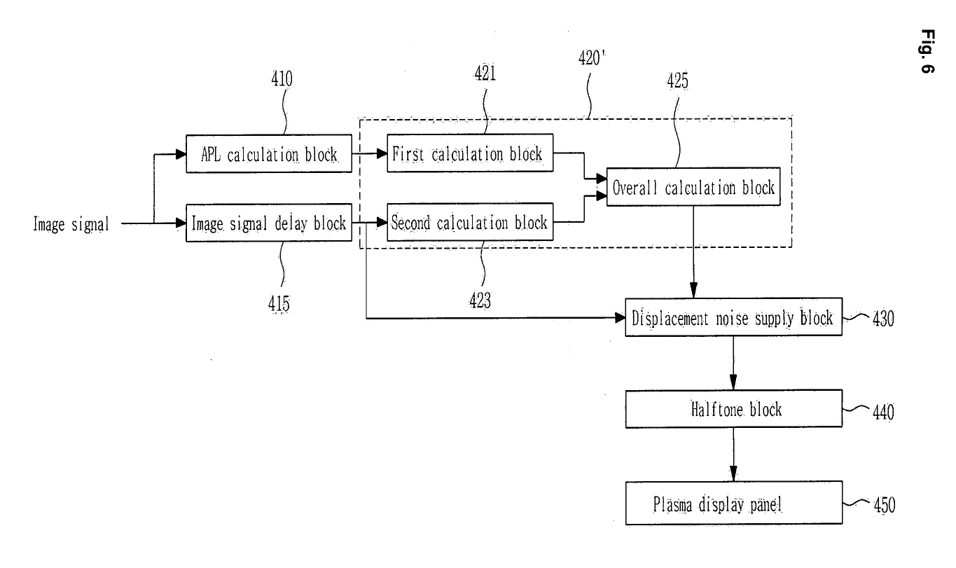

FIG. 6 is a block diagram of a plasma display apparatus according to a second embodiment of the present invention. As shown in FIG. 6, the plasma display apparatus of the second embodiment comprises an APL calculation block 410, a displacement noise calculation block 420′, a displacement noise supply block 430, a halftone block 440, and a plasma display panel 450.

The APL calculation block 410 calculates an APL upon receipt of an image signal. At this point, the APL is a value obtained by dividing the total sum of gray levels of entire pixels by the number of entire pixels of one frame.

An image signal delay block 415 receives an image signal and delays the image signal for a predetermined time period, i.e., one frame. At this point, the image signal delay block 415 includes a memory block (not shown) for temporarily storing an image signal corresponding to one frame, to thus delay the image signal for a predetermined time period. Since the APL is a value obtained by dividing the total sum of entire pixels by the number of entire pixels, a delay for a predetermined time period, i.e., one frame, is done.

The displacement calculation block 420′ calculates the intensity of displacement noise corresponding to the amount of displacement of an image corresponding to an image signal according to the APL calculated by the APL calculation block 410, calculates the intensity of displacement noise using a gray level value corresponding to each pixel of the image signal outputted from the signal delay block 415, and calculates the intensity of overall displacement noise by multiplying the intensity of displacement noise depending on the APL and the intensity of displacement noise depending on the gray level. That is, the displacement noise calculation block 420′ calculates the intensity of displacement noise by using a displacement noise calculation value including the APL and the gray level value.

The displacement noise calculation block 420′ comprises a first calculation block 421, a second calculation block 423, and an overall calculation block 425. The displacement calculation block 420 calculates the intensity of displacement noise corresponding to the amount of displacement of an image corresponding to an image signal according to a displacement noise calculation value including the APL calculated by the APL calculation block 410. The result of the calculation of the first calculation block 421 corresponds to NAPL of the above-described mathematical formula. The second calculation block 423 calculates the intensity of displacement noise according to a displacement noise calculation value including the gray level value of each pixel of the image signal outputted from the image signal delay block 415. The result of the calculation of the second calculation block 423 corresponds to NGL of the above-described mathematical formula. The overall calculation block 425 calculates the intensity of overall displacement noise. The result of the calculation of the overall calculation block 425 corresponds to NLEVEL of the above-described mathematical formula.

The displacement noise supply block 430 supplies a displacement noise signal to an image signal delayed for one frame according to the intensity of displacement noise calculated by the displacement noise calculation block 420. Therefore, the image signal outputted from the displacement noise supply block 430 corresponds to an image displaced a predetermined amount from the image generated from the original image signal. That is, the first calculation block 421 operates using an APL corresponding to an (n-1)th frame, and the second calculation block 423 operate using an image signal corresponding to the (n-1)th frame. Subsequently, a displacement noise signal for the (n-1)th frame is applied to the image signal for the (n-1)th frame.

The halftone block 440 performs halftoning for the image signal to which the displacement noise signal is applied.

The plasma display panel 450 displays an image corresponding to the signal outputted from the halftone block 440.

Next, an image processing method of a plasma display panel according to the second embodiment of the present invention will be described in detail with reference to the accompanying drawings.

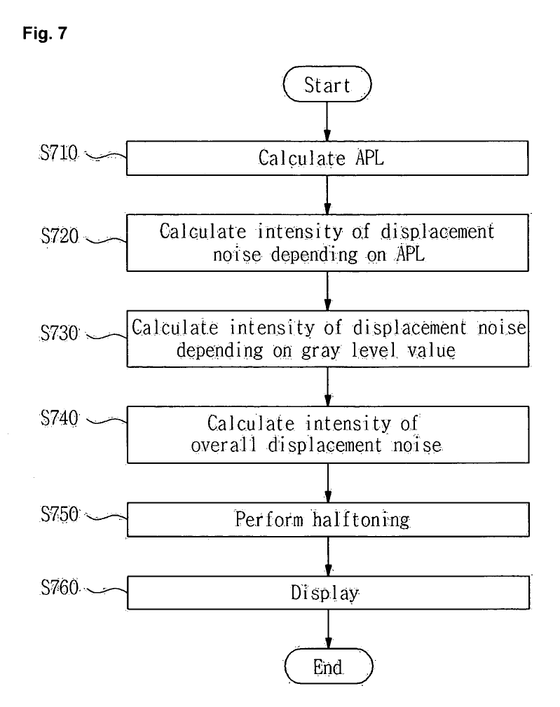

FIG. 7 is a sequence diagram of an image processing method according to the second embodiment of the present invention.

First, an APL calculation block 410 receives an image signal, and then calculates an APL by calculating the total sum of gray levels of entire pixels and dividing the total sum by the number of entire pixels (S710).

A first calculation block 421 of a displacement noise calculation block 420′ calculates the intensity of overall displacement noise corresponding to the amount of displacement of an image corresponding to an image signal according to a displacement noise calculation value including the APL calculated by the APL calculation block 410 (S720).

A second calculation block 423 of the displacement noise calculation block 420′ calculates the intensity of overall displacement noise by using a displacement noise calculation value including a gray level value corresponding to each pixel of the image signal outputted from the image signal delay block 415 (S730).

The overall calculation block 425 calculates the intensity of overall displacement noise by multiplying the result of calculation of the first calculation block 421, the result of calculation of the second calculation block 423 and a proportional constant representing the characteristics of a panel (S740).

A halftone block 440 performs halftoning for the image signal to which the displacement noise signal is applied (S750), and a plasma display panel 450 displays a halftoned image signal (S760). Subsequently, an image displaced a predetermined amount from the image generated from the original image signal is displayed.

The invention being thus described, it will be obvious that the same may be varied in many ways, Such variations are not to be regarded as a departure from the spirit and scope of the invention, and all such modifications as would be obvious to one skilled in the art area intended to be included within the scope of the following claims.

What is claimed is:

1. A plasma display apparatus, comprising:
an APL calculation block for calculating an APL upon receipt of an image signal;
a displacement noise calculation block for calculating the intensity of overall displacement noise corresponding to the amount of displacement of an image of the image signal according to a displacement noise calculation value including the APL;
a displacement noise supply block for supplying a displacement noise signal to the image signal according to the intensity of the overall displacement noise;
a halftone block for performing halftoning for the image signal to which the displacement noise signal is applied; and
a plasma display panel for displaying an image corresponding to the signal output from the halftone block.

2. The plasma display apparatus as claimed in claim 1, wherein the displacement noise calculation block consists of a) a first calculation block for calculating the intensity of displacement noise corresponding to the amount of displacement of an image of the image signal according the APL calculated by the APL calculation block, b) a second calculation block for calculating the intensity of displacement noise according to a gray level value corresponding to the image signal, and c) an overall calculation block for calculating the intensity of overall displacement noise according to the displacement noise calculation value including the result of calculation of the first calculation block and the result of calculation of the second calculation block.

3. The plasma display apparatus as claimed in claim 1, wherein the displacement noise calculation block calculates the intensity of overall displacement noise which becomes greater as the APL becomes smaller.

4. The plasma display apparatus as claimed in claim 2, wherein the second calculation block calculates the intensity of displacement noise which becomes greater as the gray level value becomes smaller.

5. The plasma display apparatus as claimed in claim 2, wherein the first calculation block calculates the intensity of displacement noise which becomes greater as the APL becomes smaller, and the second calculation block calculates the intensity of displacement noise which becomes greater as the gray level becomes smaller.

6. The plasma display apparatus as claimed in claim 2, wherein the displacement noise calculation block calculates the intensity of overall noise according to the following mathematical formula:
NLEVEL=a*NAPL
wherein NLEVEL is the intensity of overall displacement noise, NAPL is the intensity of displacement noise depending on an APL, and ais a proportional constant.

7. The plasma display apparatus as claimed in claim 1, wherein the displacement noise calculation block calculates the intensity of overall noise according to the following mathematical formula:
NLEVEL=a*(NAPL*NGL)
wherein NLEVEL is the intensity of overall displacement noise, NAPL is the intensity of displacement noise depending on an APL, NGL is the intensity of displacement noise depending on the gray level of a pixel and ais a proportional constant.

8. A plasma display apparatus, comprising:
an APL calculation block for calculating an APL upon receipt of an image signal;
a displacement noise calculation block consisting of a first calculation block for calculating the intensity of displacement noise corresponding to the amount of displacement of an image of the image signal according to a displacement noise calculation value including the APL calculated by the APL calculation block, a second calculation block for calculating the intensity of displacement noise according to a displacement noise calculation value including a gray level value corresponding to the image signal, and an overall calculation block for calculating the intensity of overall displacement noise according to the displacement noise calculation value including the result of calculation of the first calculation block and the result of calculation of the second calculation block;
a displacement noise supply block for supplying a displacement noise signal to the image signal according to the intensity of the overall displacement noise;
a halftone block for performing halftoning for the image signal to which the displacement noise signal is applied; and
a plasma display panel for displaying an image corresponding to the signal output from the halftone block.

9. The plasma display apparatus as claimed in claim 8, wherein the first calculation block calculates the intensity of overall displacement noise which becomes greater as the APL becomes smaller.

10. The plasma display apparatus as claimed in claim 8, wherein the second calculation block calculates the intensity of displacement noise which becomes greater as the gray level value becomes smaller.

11. The plasma display apparatus as claimed in claim 8, wherein the first calculation block calculates the intensity of displacement noise which becomes greater as the APL becomes smaller, and the second calculation block calculates the intensity of displacement noise which becomes greater as the gray level becomes smaller.

12. The plasma display apparatus as claimed in claim 8, wherein the displacement noise calculation block calculates the intensity of overall noise according to the following mathematical formula:
NLEVEL=a*(NAPL*NGL)
wherein NLEVEL is the intensity of overall displacement noise, NAPL is the intensity of displacement noise depending on an APL, NGL is the intensity of displacement noise depending on the gray level of a pixel and ais a proportional constant.

13. An image processing method of a plasma display apparatus, comprising the steps of:
calculating an APL upon receipt of an image signal;
calculating the intensity of overall displacement noise corresponding to the amount of displacement of an image of the image signal according to a displacement noise calculation value including the calculated APL;
supplying a displacement noise signal to the image signal corresponding to the intensity of the overall displacement noise;
performing halftoning for the image signal to which the displacement noise signal is applied; and
supplying the halftoned image signal to electrodes.

14. The method as claimed in claim 13, wherein thee step of calculating the intensity of overall displacement noise consists of the steps of: a) calculating the intensity of displacement noise corresponding to the amount of displacement of an image of the image signal according a displacement noise calculation value including the; b) calculating the intensity of displacement noise using a displacement noise calculation value including a gray level value; and c) calculating the intensity of overall displacement noise according to the intensity of displacement noise depending on the APL and the intensity of displacement noise depending on the gray level value.

15. The method as claimed in claim 13, wherein the intensity of overall displacement noise becomes greater as the APL becomes smaller.

16. The method as claimed in claim 14, wherein the intensity of overall displacement noise becomes greater as the gray level value becomes smaller.

17. The method as claimed in claim 14, wherein the intensity of overall displacement noise becomes greater as the APL becomes smaller, and the intensity of overall displacement noise becomes greater as the gray level value becomes smaller.

18. The method as claimed in claim 13, wherein the intensity of overall displacement noise is calculated according to the following mathematical formula:
NLEVEL=a*NAPL
wherein NLEVEL is the intensity of overall displacement noise, NAPL is the intensity of displacement noise depending on an APL, and ais a proportional constant.

19. The method as claimed in claim 14, wherein the intensity of overall noise is calculated according to the following mathematical formula:
NLEVEL=a*(NAPL*NGL)
wherein NLEVEL is the intensity of overall displacement noise, NAPL is the intensity of displacement noise depending on an APL, NGL is the intensity of displacement noise depending on the gray level of a pixel and ais a proportional constant
